(19) United States
(12) Patent Application Publication
(10) Pub. No.: US 2018/0297768 A1
(43) Pub. Date: Oct. 18, 2018

(54) TWO LIQUID TYPE CARTRIDGE SYRINGE HAVING IMPROVED EXHAUST STRUCTURE

(71) Applicant: Moon-Kyu YOON, Daegu (KR)

(72) Inventor: Moon-Kyu YOON, Daegu (KR)

(21) Appl. No.: 15/768,008

(22) PCT Filed: Jul. 1, 2016
(86) PCT No.: PCT/KR2016/007139

§ 371 Date: Apr. 13, 2018

(30) Foreign Application Priority Data
Oct. 13, 2015 (KR) 10-2015-0142625

(51) Int. Cl. B65D 81/32; B05C 17/01

(52) U.S. Cl. CPC B65D 81/325; B05C 17/0116

(57) ABSTRACT

Disclosed is a two liquid type cartridge syringe having an improved exhaust structure, and more particularly, a two liquid type cartridge syringe having an improved exhaust structure, in which an exhaust structure for discharging air remaining in a cartridge to the outside is improved, in order to ensure that the air remaining in the cartridge is completely exhausted in the process of assembling a piston with the cartridge, thereby preventing the remaining air from suppressing forward movement of the piston inside the cartridge.

### CROSS REFERENCE TO RELATED PATENT APPLICATIONS

This application claims the benefit under 35 U.S.C. Section 371, of PCT International Application No. PCT/KR2016/007139, filed Jul. 1, 2016, which claimed priority to Korean Patent Application No. KR 10-2015-0142625, filed Oct. 13, 2015, the disclosures of which are hereby incorporated by the references.

### TECHNICAL FIELD

The present invention relates to a two liquid type cartridge syringe having an improved exhaust structure, and more particularly, to a two liquid type cartridge syringe having an improved exhaust structure, in which an exhaust structure for discharging air remaining in a cartridge to the outside is improved, in order to ensure that the air remaining in the cartridge is completely exhausted in the process of assembling a piston with the cartridge, thereby preventing the remaining air from suppressing forward movement of the piston inside the cartridge.

### BACKGROUND ART

A generally used liquid-phase resin base such as silicon or epoxy, may freely embody the desired shape of an object via curing, but takes a long time to cure.

Therefore, conventionally, in order to reduce the curing time of liquid-phase silicon or epoxy resin, the base resin is mixed with a curing agent at a predetermined ratio so as to achieve a reduction in the curing time of the resin by the curing agent.

In addition, in recent years, for convenience of use, a two liquid type cartridge syringe, in which a base such as a liquid-phase silicon base and a curing agent for facilitating the curing of the base are separately stored in respective cylinders, has been developed and is currently in use.

Such a two liquid type cartridge syringe is configured such that pistons are respectively provided in the cylinders and a mixing tip is coupled to a common discharge hole formed between the cylinders, whereby the base and the curing agent provided in the respective cylinders are discharged in appropriate amounts through the discharge hole by collective forward movement of the pistons, and are then mixed by the mixing tip to thereby be discharged.

Therefore, since the base and the curing agent, stored in the respective cylinders, are mixed and discharged in appropriate amounts by the collective pressing of the pistons disposed in the respective cylinders, the base may be rapidly cured by mixing the appropriate amount of curing agent therewith.

Here, the piston, which is provided to move forwards and backwards in the cylinder so as to press and discharge the base or the curing agent stored in the cylinder, as illustrated in FIG. 6, is configured such that one or more sealing rings are disposed on the outer wall thereof.

Meanwhile, the process of injecting the base or the curing agent into the cylinder defined in the cartridge syringe is performed by injecting the base or the curing agent into the cylinder, inserting the piston into the cylinder to seal the cylinder. This process, however, inevitably causes air's remaining in the cylinder, which is not discharged to the outside.

When the air remains in the cylinder as described above, this may cause decomposition such as, for example, curing of the base or the curing agent stored in the cylinder. In particular, when an aircushion phenomenon occurs due to air that remains during the collective pressing of the pistons via an injector, and it is difficult to perform the collective pressing of the pistons via the injector.

That is, since it is difficult to completely exhaust the air inside the cylinder, an aircushion may be generated between a piston 20 and a liquid material. Therefore, when a filler (the base or the curing agent) is injected via the piston, the aircushion may prevent the introduction of the compressive ring, which may make it impossible for the base or the curing agent, stored in the cylinder, to be injected in a fixed amount.

That is, since the aircushion is formed between the piston 20 and the injected base or curing agent when the air inside the cylinder is not completely exhausted, the aircushion may prevent the introduction of the piston when the filler (the base or the curing agent) is injected via the piston, and thus it is impossible for the base or the curing agent stored in the cylinder to be injected in a fixed amount.

In order to solve this problem, in the art, as illustrated in FIG. 10, when a piston P is inserted into a cylinder C into which a base or a curing agent has been injected, a pin P′ is inserted between the piston P and the inner wall of the cylinder C so that the air remaining in the cylinder C is exhausted through a gap that is defined between the piston P and the cylinder C by the pin P′, in order to minimize the phenomenon in which air remains between the piston and the base or the curing agent.

However, with the above-described structure in which the pin is inserted in order to exhaust the remaining air, a worker always needs to insert the pin P′, and in the process of removing the pin after inserting the piston, the base or the curing agent adhered on the surface of the pin may cause contamination of a cartridge syringe including the cylinder and the piston.

Therefore, the worker always needs to perform an operation of cleaning the contaminated region of the cartridge syringe after performing exhaustion using the pin, which is very troublesome and decreases productivity.

In another example, in recent years, as illustrated in FIG. 11, there is provided an exhaust structure in which a piston P is formed with an exhaust hole H so that air remaining in a cylinder C is discharged through the exhaust hole H in the process of inserting the piston P into the cylinder C into which a base or a curing agent has been injected, after which the exhaust hole H is closed by a sealing cap C′ once the piston P has been completely inserted.

That is, in the process of introducing the piston into the cylinder, the air remaining in the cartridge is discharged to the outside through the exhaust hole H formed in the piston, after which the sealing cap C1 is inserted into the exhaust hole to close the exhaust hole in the piston.

With this configuration, although problems caused when the pin is inserted to discharge the air remaining in the cylinder may be solved, the above-described exhaust structure requires that the piston and the sealing cap be separately molded, and must be accompanied by the process of inserting the sealing cap into the exhaust hole formed in the piston after the exhaustion of air is completed, which may increase extra expenses upon the manufacture of such a two liquid type cartridge syringe and may decrease productivity.

In addition, when the exhaust hole is not completely sealed by the sealing cap, in the process of pressing and discharging the base or the curing agent by the piston, the base or the curing agent may backflow through the exhaust hole, thereby leaking to the outside.

### DISCLOSURE

### Technical Problem

Therefore, the present invention has been made in view of the related art, and it is an object of the present invention to provide a two liquid type cartridge syringe having an improved exhaust structure, in which an exhaust structure for discharging air remaining in a cartridge to the outside is improved in order to ensure that the air remaining in the cartridge is completely exhausted in the process of assembling a piston with the cartridge, whereby the reliable discharge of the air remaining in a cylinder may be achieved without the manufacture and assembly of a separate pin or a sealing cap, and a base or a curing agent stored in the cylinder may be discharged in a fixed amount by the pressing of the piston.

### Technical Solution

The above object is achieved by the following configuration provided in the present invention.

According to the present invention, a two liquid type cartridge syringe includes a main body including a pair of cylinders, each formed in a tip end thereof with a discharge hole, and a piston configured to be introduced into a corresponding one of the cylinders so as to pressurize a filler stored in the cylinder and discharge the filler through the discharge hole, wherein the piston includes a compressive rim portion and a sealing rim portion configured respectively so as to be brought into close contact with an inner wall of the cylinder and a connecting portion configured to interconnect the rim portions with a space therebetween, and the piston is configured so that the compressive rim portion, the connecting portion, and the sealing rim portion are sequentially introduced into the cylinder through an opened rear end of the cylinder, wherein at least one exhaust path is formed in the compressive rim portion and the connecting portion to discharge air remaining in the cylinder filled with the filler to an outer wall of the connecting portion, and wherein the piston sequentially performs an exhaust process of discharging the air remaining in the cylinder through the exhaust path while introducing the compressive rim portion into the cylinder and a sealing process of sealing a rear portion of the cylinder, from which the remaining air has been exhausted, via the sealing rim portion, so as to seal the cylinder in a state in which the air remaining in the cylinder has been discharged.

The compressive rim portion may include a compressive ring disposed along an outer diameter thereof so as to be brought into close contact with the inner wall of the circumscribed cylinder via the compressive ring, and the sealing rim portion may include a sealing ring disposed along an outer diameter thereof so as to be brought into close contact with the inner wall of the circumscribed cylinder via the sealing ring.

The rear portion of the cylinder, into which the piston is introduced, may be formed with an exhaust section that is not closed by the sealing rim portion, so that the remaining air, discharged along the exhaust path in the exhaust process, is exhausted outwards along the exhaust section, and so that the cylinder is sealed by the sealing rim portion of the piston once the sealing rim portion has passed through the exhaust section.

The exhaust section formed in the rear portion of the cylinder may include a conical decreasing tube portion, a diameter of which gradually decreases from a rear side to a front side, and the sealing rim portion of the piston to be introduced into the cylinder has a diameter smaller than that of the decreasing tube portion, so that the sealing rim portion is spaced apart from an inner wall of the decreasing tube portion in a process of passing through the conical decreasing tube portion.

In addition, the exhaust section may include an exhaust groove portion formed by cutting the rear portion of the cylinder in a longitudinal direction, so that the sealing rim portion of the piston discharges the air, which has been exhausted through the exhaust path, outwards while moving forward a preset length along the inner wall of the cylinder, and then seals the inner wall of the cylinder.

The rear portion of the cylinder may be formed with the conical decreasing tube portion and the exhaust groove portion in front of the conical decreasing tube portion.

### Advantageous Effects

As described above, in the present invention, a piston is sequentially formed with a compressive rim portion, a connecting portion, and a sealing rim portion, and at least one exhaust path is formed between the compressive rim portion and the connecting portion for communication of the inside of a cylinder with the outer wall of the connecting portion.

In addition, an exhaust section, which includes an exhaust groove portion and a conical decreasing tube portion, is formed in the inner wall of the cylinder, so that the air, which has been exhausted from the cylinder along the exhaust path, is completely exhausted, and then, the cylinder is completely sealed via the sealing rim portion.

With this configuration, an exhaust process of discharging the air remaining in the cylinder through the exhaust path while introducing the compressive rim portion of the piston into the cylinder, and a sealing process of sealing the rear portion of the cylinder, from which the remaining air has been exhausted, via the sealing rim portion may be performed in stages.

Accordingly, the present invention enables the reliable exhaustion of the air remaining in the cylinder without causing any trouble or increasing manufacturing costs, which conventionally occurs when a pin is inserted between the piston and the cylinder to secure an exhaust space or when an exhaust hole is formed in the piston and a sealing cap is inserted and fixed after completion of exhaustion.

In addition, in the present invention, a filling space is recessed in the connecting portion formed between the compressive rim portion and the sealing rim portion so that some of the remaining air, which has not yet discharged through the exhaust section, is maintained in the filling space, rather than being present between a filler and the piston. Thereby, a fixed amount of filler may continuously remain in the cylinder, and the discharge of a fixed amount of filler is possible.

In this way, a two liquid type cartridge syringe according to the present invention may allow a constant amount of fillers to always be mixed and discharged through respective discharge holes by the simultaneous forward movement of respective pistons.

### DESCRIPTION OF DRAWINGS

FIGS. 1 to 3 illustrate the overall configuration of a two liquid type cartridge syringe having an improved exhaust structure proposed according to an exemplary embodiment of the present invention,

FIGS. 4 to 6 illustrate the detailed configuration of a piston in the two liquid type cartridge syringe having an improved exhaust structure proposed according to the exemplary embodiment of the present invention,

FIGS. 7 to 9 illustrate a process of exhausting remaining air by the insertion of a piston and a process of sealing an opened cylinder in the two liquid type cartridge syringe having an improved exhaust structure proposed according to the exemplary embodiment of the present invention, and

FIGS. 10 and 11 illustrate the exhaust structures for conventional two liquid type cartridge syringes.

### BEST MODE

Hereinafter, a two liquid type cartridge syringe having an improved exhaust structure, proposed according to an exemplary embodiment of the present invention, will be described in detail with reference to the accompanying drawings.

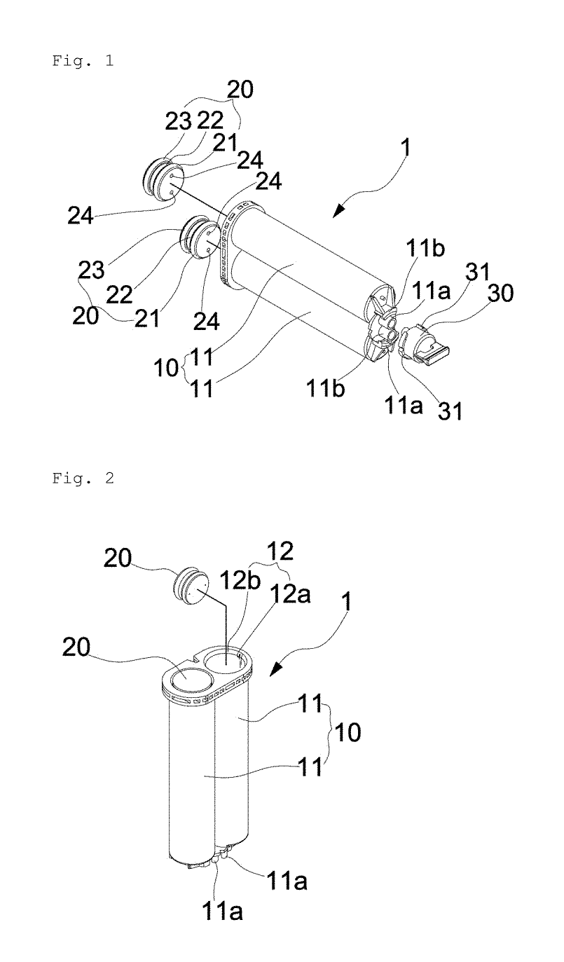

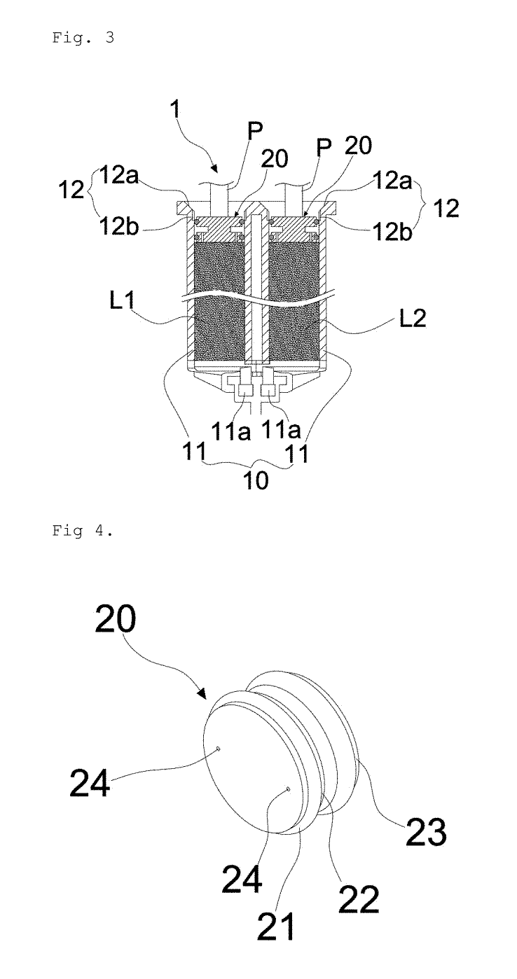

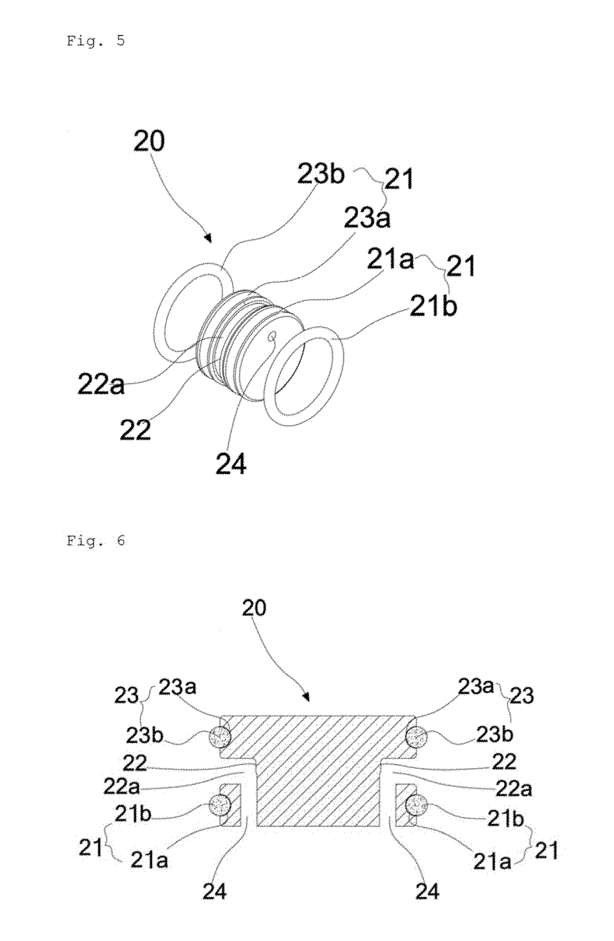

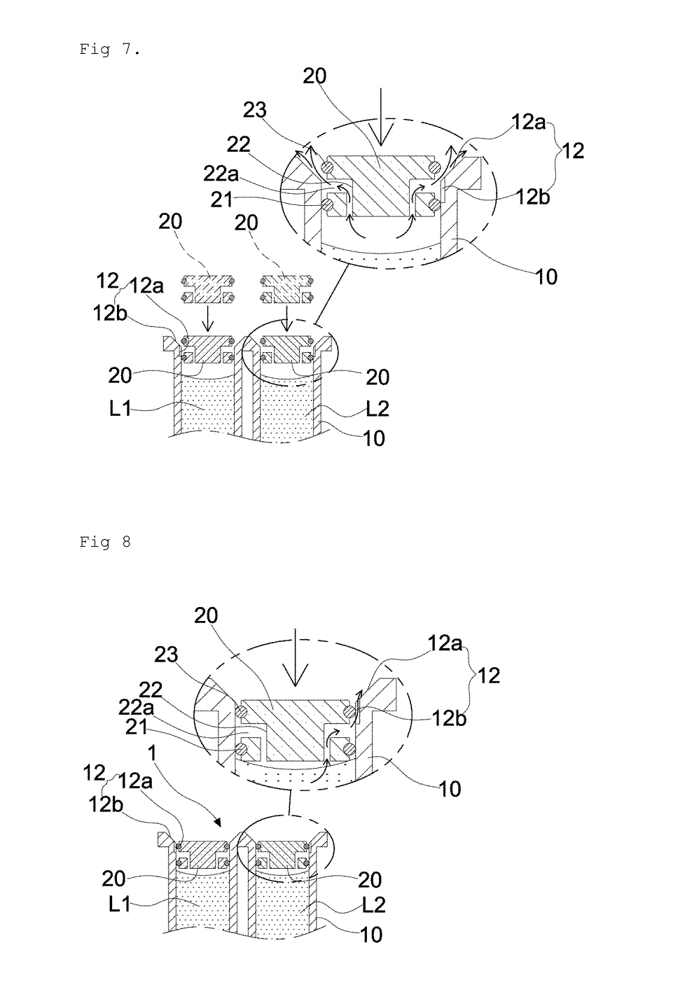

FIGS. 1 to 3 illustrate the overall configuration of a two liquid type cartridge syringe having an improved exhaust structure proposed according to an exemplary embodiment of the present invention, FIGS. 4 to 6 illustrate the detailed configuration of a piston in the two liquid type cartridge syringe having an improved exhaust structure proposed according to the exemplary embodiment of the present invention, and FIGS. 7 to 9 illustrate a process of exhausting remaining air by the insertion of a piston and a process of sealing an opened cylinder in the two liquid type cartridge syringe having an improved exhaust structure proposed according to the exemplary embodiment of the present invention.

The two liquid type cartridge syringe 1 having an improved exhaust structure, proposed according to an exemplary embodiment of the present invention, as illustrated in FIGS. 1 to 3, is a device that mixes and discharges a base and a curing agent, which are fillers L1 and L2 stored in a pair of cylinders 11.

The two liquid type cartridge syringe 1 includes a main body 10, which includes a pair of cylinders 11 formed in a tip end thereof with discharge holes 11a, respectively, and pistons 20, which are configured to be introduced into the respective cylinders 11 to pressurize the fillers L1 and L2 stored in the cylinders 11 and discharge the same through the discharge holes 11a.

The main body 10 including the pair of cylinders 11 and the pistons 20 are usually configured with plastic injection-molded articles, but may be replaced with glass or metal articles, for example, as needed.

Then, a tip end portion of the main body 10, in which the discharge holes 11a of the respective cylinders 11 are formed, is formed with a mounting portion, which is provided with a pair of mounting blades 11b. Upon storage, a sealing cap is fixed to a mounting end via the mounting portion to maintain airtightness to thus prevent curing of the filler stored in each cylinder, and when in use, a mixing tip having the mounting end is assembled via the mounting portion to mix and discharge an appropriate amount of filler stored in the cylinder.

That is, the two liquid type cartridge syringe 1 is usually mounted in an extrusion gun (not illustrated), and the respective pistons 20 are pressurized forward at the same time by respective push rods mounted in the extrusion gun, thereby being moved forward along the respective cylinders 11.

At this time, the base and the curing agent, which are the fillers L1 and L2 inside the respective cylinders 11, are compressed by the simultaneous pressurization of the pistons 20, which are moved forward at the same time along the respective cylinders 11 by the extrusion gun, thereby being discharged in appropriate amounts through the discharge holes 11a at the same time. Then, the fillers L1 and L2, which include the base and the curing agent discharged in appropriate amounts through the discharge holes 11a, are mixed with each other in appropriate amounts while passing through the mixing tip, so that a mixture thereof is discharged.

Meanwhile, the process of injecting the fillers L1 and L2 into the respective cylinders 11 formed in the main body 10 is performed by filling the respective cylinders 11 with appropriate amounts of fillers L1 and L2 through opened rear ends thereof, and thereafter, inserting the pistons 20 into the cylinders 11 and sealing the cylinders 11.

In addition, in the present embodiment, a unique exhaust structure is added to the above-described two liquid type cartridge syringe 1 in order to realize the reliable discharge of air remaining between the filler and the piston by merely using a simplified assembly process of inserting the piston 20 into the cylinder 11 filled with the filler L1 or L2, without the above-described conventional process of inserting and removing the separate exhaust pin for exhausting the air remaining between the filler and the piston or the above-described conventional process of closing the exhaust hole using the sealing cap.

To this end, in the present embodiment, as illustrated in FIGS. 4 to 6, the piston 20 includes a compressive rim portion 21 and a sealing rim portion 23, which are configured to be brought into close contact with the inner wall of the cylinder 11, and a connecting portion 22 configured to interconnect the two rim portions with a space therebetween. The piston 20 configured as described above, as illustrated in FIGS. 7 to 9, is introduced into the corresponding cylinder 11 through the opened rear end of the cylinder 11 in the sequence of the compressive rim portion 21, the connecting portion 22, and the sealing rim portion 23 thereof.

Here, the compressive rim portion 21 is formed with a mounting groove 21a along the outer diameter thereof, and a compressive ring 21b is mounted in the mounting groove 21a so that the compressive rim portion 21 is brought into close contact with the inner wall of the circumscribed cylinder 11 via the compressive ring 21b. The sealing rim portion 23 is formed with a mounting groove 23a along the outer diameter thereof and a sealing ring 23b is mounted in the mounting groove 23a so that the sealing rim portion 23 is brought into close contact with the inner wall of the circumscribed cylinder 11 via the sealing ring 23b.

The compressive ring 21b and the sealing ring 23b are formed of an elastic material such as silicon or rubber and elastically come into close contact with the inner wall of the cylinder 11, thereby realizing the compression of the filler L1 or L2 stored in the cylinder 11 and the sealing of the cylinder 11 filled with the filler L1 or L2.

In addition, at least one exhaust path 24 is formed in the compressive rim portion 21 and the connecting portion 22 to discharge the air remaining in the cylinder 11, which has been filled with the filler L1 or L2, to the outer wall of the connecting portion 22.

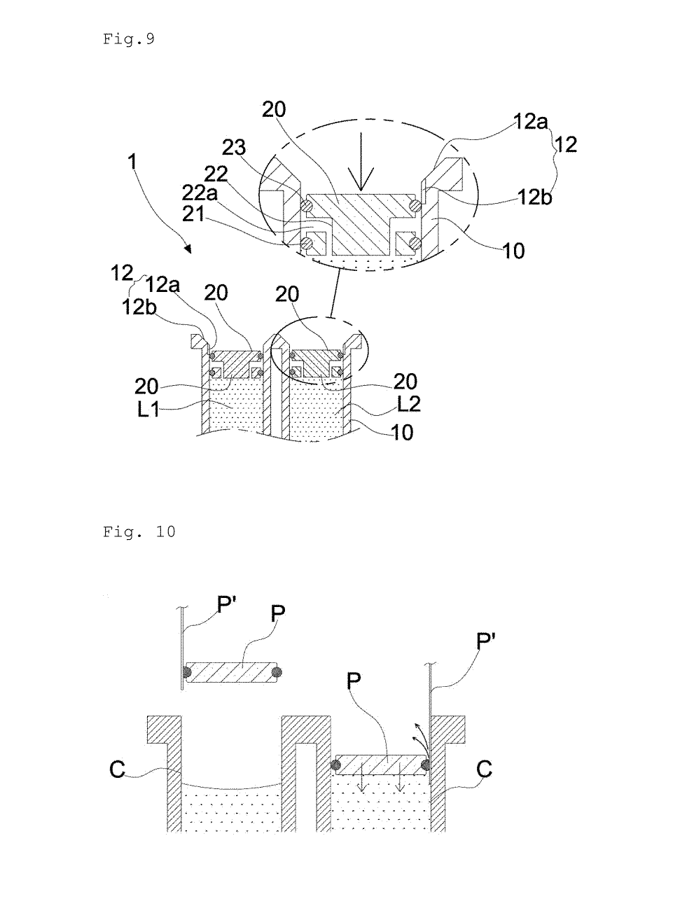

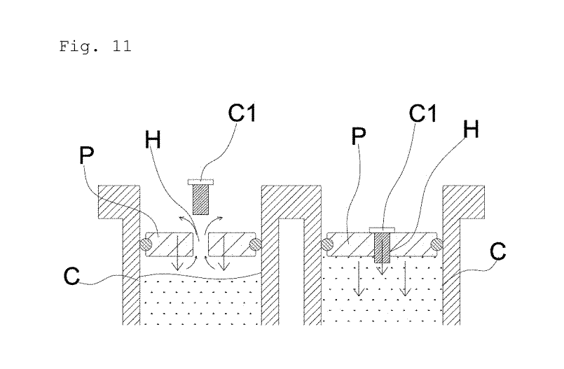

Thus, as illustrated in FIGS. 7 and 8, the piston 20 seals the cylinder 11 in the state in which the air remaining in the cylinder 11 has been discharged, as a result of sequentially performing an exhaust process of discharging the air remaining between the filler L1 or L2 and the compressive rim portion 21 through the exhaust path 24 while introducing the compressive rim portion 21 into the cylinder and a sealing process of sealing the rear of the cylinder 11, from which the remaining air has been exhausted, via the sealing rim portion 23 as illustrated in FIG. 9.

That is, the piston 20, to be introduced into the corresponding cylinder 11 filled with the filler L1 or L2, discharges the air remaining between the filler L1 or L2 and the compressive rim portion 21 through the exhaust path 24 to the outer wall of the connecting portion 22 while compressing the filler L1 or L2 containing the air using the compressive rim portion 21, and thereafter seals the opened rear end of the cylinder 11 via the sealing rim portion 23.

In addition, in the present embodiment, in which the piston 20 having the exhaust structure described above is inserted into the cylinder 11 to realize the discharge of the remaining air and the sealing of the cylinder 11 in stages, an exhaust section 12 is further formed in the rear portion of the cylinder 11 so as not to be closed by the sealing rim portion 23. As such, the remaining air, which is introduced into a filling space 22a through the exhaust path 24, is exhausted outwards along the exhaust section. Once the sealing rim portion 23 of the piston 20 has passed through the exhaust section, the cylinder 11 is sealed by the sealing rim portion 23.

The exhaust section 12 formed in the rear portion of the cylinder 11 includes a conical decreasing tube portion 12a, the diameter of which gradually decreases from the rear to the front, and an exhaust groove portion 12b, which is formed by cutting the rear portion of the cylinder 11 in the longitudinal direction to a preset length.

In the present embodiment, the conical decreasing tube portion 12a and the exhaust groove portion 12b in front of the conical decreasing tube portion 12a are formed respectively in the rear portion of the cylinder 11, so that the remaining air is discharged outwards along the exhaust path 24 while the sealing rim portion 23b passes through the decreasing tube portion 12a, and then a very small amount of the remaining air is discharged outwards along the exhaust path 24 while the sealing rim portion 23 passes through the exhaust groove portion 12b.

That is, the sealing rim portion 23 of the piston 23 to be introduced into the cylinder 11 has a diameter smaller than that of the decreasing tube portion 12a. Therefore, the sealing rim portion 23 is spaced apart from the inner wall of the decreasing tube portion 12a while passing through the conical decreasing tube portion 12a, thereby primarily discharging the remaining air outwards through the exhaust path 24. Thereafter, the sealing rim portion 23 of the piston 20, which has passed through the decreasing tube portion 12a, secondarily discharges a small amount of the remaining air exhausted through the exhaust path 24 outwards while moving forward a preset length along the inner wall of the cylinder 11, and then completely seals the cylinder 11 once it has passed through the exhaust section 12.

In addition, in the present embodiment, the filling space 22a is recessed in the connecting portion 22 so that a very small amount of the remaining air, which has been exhausted along the exhaust path 24 to the outer wall of the connecting portion 22, but has not yet been discharged through the exhaust section 12, remains in the state of filling the filling space 22a formed in the connecting portion 22.

With the above-described configuration, no air remains between the fillers L1 and L2 stored in the cylinders 11 and the respective pistons 20, and appropriate amounts of the fillers L1 and L2 are maintained in the compressed state by the pistons 20.

Accordingly, even if slightly different amounts of fillers L1 and L2 are injected into the respective cylinders 11, the fillers L1 and L2 are compressed and discharged in the same amount by the pistons 20 since the depth, to which the pistons 20 are inserted into the respective cylinders 11, is limited by the length of the exhaust section.

In this way, as a result of performing the exhaust process of discharging the air remaining in the cylinder 11 outwards through the exhaust path 24 and the sealing process of sealing the rear portion of the cylinder 11, from which the remaining air has been exhausted, in stages by simply inserting the piston 20 having an exhaust structure into the corresponding cylinder 11 filled with the filler L1 or L2, the two liquid type cartridge syringe 1 according to the present embodiment may omit a conventional complicated exhaust operation that involves the insertion of an exhaust pin or a sealing cap, and consequently may realize the reliable exhaustion of the air remaining in the cylinder and the discharge of a fixed amount of the filler without incurring an increase in manufacturing costs.

1. A two liquid type cartridge syringe comprising:
a main body comprising a pair of cylinders, each formed in a tip end thereof with a discharge hole; and a piston configured to be introduced into a corresponding one of the cylinders so as to pressurize a filler stored in the cylinder and discharge the filler through the discharge hole,
wherein the piston comprises a compressive rim portion and a sealing rim portion configured respectively so as to be brought into close contact with an inner wall of the cylinder and a connecting portion configured to interconnect the rim portions with a space therebetween, and the piston is configured so that the compressive rim portion, the connecting portion, and the sealing rim portion are sequentially introduced into the cylinder through an opened rear end of the cylinder,
wherein at least one exhaust path is formed in the compressive rim portion and the connecting portion to discharge air remaining in the cylinder filled with the filler to an outer wall of the connecting portion, and
wherein the piston sequentially performs an exhaust process of discharging the air remaining in the cylinder through the exhaust path while introducing the compressive rim portion into the cylinder and a sealing process of sealing a rear portion of the cylinder, from which the remaining air has been exhausted, via the sealing rim portion, so as to seal the cylinder in a state in which the air remaining in the cylinder has been discharged.

2. The two liquid type cartridge syringe according to claim 1, wherein the compressive rim portion comprises a compressive ring disposed along an outer diameter thereof so as to be brought into close contact with the inner wall of the circumscribed cylinder via the compressive ring.

3. The two liquid type cartridge syringe according to claim 1, wherein the sealing rim portion comprises a sealing ring disposed along an outer diameter thereof so as to be brought into close contact with the inner wall of the circumscribed cylinder via the sealing ring.

4. The two liquid type cartridge syringe according to claim 1, wherein the rear portion of the cylinder, into which the piston is introduced, is formed with an exhaust section that is not closed by the sealing rim portion, so that the remaining air, discharged along the exhaust path in the exhaust process, is exhausted outwards along the exhaust section, and so that the cylinder is sealed by the sealing rim portion of the piston once the sealing rim portion has passed through the exhaust section.

5. The two liquid type cartridge syringe according to claim 4, wherein the exhaust section formed in the rear portion of the cylinder comprises a conical decreasing tube portion, a diameter of which gradually decreases from a rear side to a front side, and the sealing rim portion of the piston to be introduced into the cylinder has a diameter smaller than that of the decreasing tube portion, so that the sealing rim portion is spaced apart from an inner wall of the decreasing tube portion in a process of passing through the conical decreasing tube portion.

6. The two liquid type cartridge syringe according to claim 4, wherein the exhaust section comprises an exhaust groove portion formed by cutting the rear portion of the cylinder in a longitudinal direction, and the sealing rim portion of the piston has a diameter smaller than that of the decreasing tube portion so as not to close the rear portion of the cylinder in a process of passing through the decreasing tube portion.
